(19) United States
(12) Patent Application Publication
(10) Pub. No.: US 2025/0360518 A1
(43) Pub. Date: Nov. 27, 2025

(54) METHOD FOR DESIGNING AND FABRICATING DIELECTROPHORETIC MICROELECTRODE ACTUATOR WITH IMPEDANCE SENSOR CHIP

(71) Applicant: ZHEJIANG NORMAL UNIVERSITY, Jinhua (CN)

(72) Inventors: CLARENCE AUGUSTINE TECK HUO TEE, Jinhua (CN); BURHANUDDIN YEOP MAJLIS, Selangor (MY); MUHAMAD RAMDZAN BUYONG, Selangor (MY); WEY PING YEO, Selangor (MY)

(21) Appl. No.: 19/001,050

(22) Filed: Dec. 24, 2024

(30) Foreign Application Priority Data
May 27, 2024 (CN) 202410661967.8

(51) Int. Cl. B03C 5/00

(52) U.S. Cl. CPC B03C 5/005; B03C 2201/26

(57) ABSTRACT

Disclosed is a method for designing and fabricating a dielectrophoretic microelectrode actuator with an impedance sensor chip, and the present disclosure is capable of utilizing dielectrophoresis technology to detect in a continuous-flow microfluid for identification, operation, classification and quantification. Examples illustrating various sizes of the present disclosure are also available, such that customizable experiments can be conducted. In the present disclosure, positive and negative dielectrophoretic forces of different types of electrodes are employed, and therefore different types of bacterial particles can be chosen for different types of operations according to experimental interests.

### CROSS-REFERENCE TO RELATED APPLICATIONS

This application claims priority to Chinese Patent Application No. 202410661967.8, filed on May 27, 2024, which is hereby incorporated by reference in its entirety.

### TECHNICAL FIELD

The present disclosure relates to the technical field of dielectrophoresis, and in particular to a method for designing and fabricating a dielectrophoretic microelectrode actuator with an impedance sensor chip on a semiconductor chip platform.

### BACKGROUND

Dielectrophoresis (DEP) is a phenomenon that a force is exerted on dielectric particles subjected to a non-uniform electric field. Charged particles are not required for the force. All particles exhibit dielectrophoretic activity in the presence of an electric field. This mechanism can be utilized for detection of bacteria.

Cell impedance is calculated based on the difference between a baseline voltage and a voltage measured after cells are attached to an electrode, which eliminates contributions of electrode-electrolyte combinations and parasitic elements. The impedance mechanism can be used to calculate a concentration of particles in a medium or sample.

The above two elements are suitable for detecting six highly virulent and antibiotic-resistant bacterial pathogens including: Enterococcus faecium, Staphylococcus aureus, Klebsiella pneumoniae, Acinetobacter baumannii, Pseudomonas aeruginosa, and Enterobacter spp. (ESKAPE) subject to bacteriological water detection and quantification.

The patent with publication No. US20040233424 discloses a chip-based device for three-dimensional microfluidic particle focusing and detection, characterized in which through the actions of fluidic driving force and dielectrophoretic forces, microparticles flow in the center of microchannels, which enhances the accuracy of subsequent detection. The chip of the present invention is fabricated by first creating microchannels on a substrate for fluid flow, including specimen channels and sheath fluid channels, carrying out two-dimensional fluid focusing on particles in the sample flow, and fabricating microelectrodes in the microchannels to provide dielectrophoretic forces for three-dimensional focusing of particles. The present invention is applicable to the counting, determination, speed measuring and sorting of all kinds of microparticles, such as cells and blood cells.

The prior art has the following defects. In the prior art, only vertically arranged electrodes are used to focus microparticles in a vertical direction, and only one type of focusing is possible, namely focusing in the vertical direction of negative DEP. The focusing is only applicable to one vertical movement of particles with one type of cell or sample. In the prior art, separation of particles and cells in one type of sample fluid is not possible. The movement of particles of interest cannot be controlled in the prior art because only vertical movements can be captured in the prior art.

Different from cells that have different sizes and shapes, the microelectrodes of the prior art remain unchanged in sizes and shapes. As a result, the electrodes may be cannot manipulate small-sized cell samples, and therefore, the samples cannot be collected after manipulation in the prior art. Therefore, an invention is needed to overcome the defects of existing arrangements of the prior art.

### SUMMARY

In order to solve the problems in the prior art, an objective of the present disclosure is to provide a method for designing and fabricating a dielectrophoretic microelectrode actuator with an impedance sensor chip, which is capable of utilizing dielectrophoresis technology to detect in a continuous-flow microfluid for identification, operation, classification and quantification.

In order to achieve the above objective, the present disclosure provides a method for designing and fabricating a dielectrophoretic microelectrode actuator with an impedance sensor chip. The method includes arranging a dielectrophoretic microelectrode actuator connected to an output channel and three input channels on a semiconductor chip, and further includes arranging an impedance microelectrode sensor with one input channel and one output channel on the same semiconductor chip, where the impedance microelectrode sensor is arranged adjacent to the dielectrophoretic microelectrode actuator, a contact pad is arranged on the semiconductor chip, the contact pad has a size of 1650 μm×1650 μm, and the dielectrophoretic microelectrode actuator and the impedance microelectrode sensor are arranged on the contact pad.

Preferably, the dielectrophoretic microelectrode actuator has a size of 900 μm×900 μm, a gap of 20 μm, and an internal microelectrode length of 800 μm; and the impedance microelectrode sensor has a size of 500 μm×500 μm, a gap of 20 μm, and an internal microelectrode length of 400 μm.

Preferably, the dielectrophoretic microelectrode actuator has a size of 2000 μm×2000 μm, a gap of 80, 70, 60, 50, 40, 30, 20 or 10 μm, and an internal microelectrode length of 405 μm; and the impedance microelectrode sensor has a size of 2000 μm×505 μm, a gap of 80, 70, 60, 50, 40, 30, 20 or 10 μm, and an internal microelectrode length of 405 μm.

Preferably, the dielectrophoretic microelectrode actuator has a size of 800 μm×800 μm, a gap of 25 μm, and an internal microelectrode length of 700 μm; and the impedance microelectrode sensor has a size of 200 μm×200 μm, a gap of 25 μm, and an internal microelectrode length of 100 μm.

Preferably, the dielectrophoretic microelectrode actuator has a length of 5000 μm on one side and 16700 μm on the other side, a gap of 25 μm, and symmetrical V-shaped microelectrodes formed on both sides; and the impedance microelectrode sensor has a length of 5000 μm on one side and 16700 μm on the other side, with a gap of 25 μm.

Beneficial effects of the method for designing and fabricating a dielectrophoretic microelectrode actuator with an impedance sensor chip of the present disclosure: the present disclosure is capable of utilizing dielectrophoresis technology to detect in a continuous-flow microfluid for identification, operation, classification and quantification. Examples illustrating various sizes of the present disclosure are also available, such that customizable experiments can be conducted. In the present disclosure, positive and negative dielectrophoretic forces of different types of electrodes are employed, and therefore different types of bacterial particles can be chosen for different types of operations according to experimental interests. The designing and fabricating method involves creation of fixed variables. The present disclosure is also capable of customizing one input and three outputs for different particle operations of interest, which covers sample collection and continuous microfluidics.

The features and advantages of the present disclosure will be described in detail with reference to the examples and the accompanying drawings.

### BRIEF DESCRIPTION OF DRAWINGS

FIG. 1 is a schematic diagram of a dielectrophoretic microelectrode actuator with an impedance sensor chip according to Example 1 of the present disclosure.

FIG. 2 is a schematic diagram of a dielectrophoretic microelectrode actuator with an impedance sensor chip according to Example 2 of the present disclosure.

FIG. 3 is a schematic diagram of a dielectrophoretic microelectrode actuator with an impedance sensor chip according to Example 3 of the present disclosure.

FIG. 4 is a schematic diagram of a dielectrophoretic microelectrode actuator with an impedance sensor chip according to Example 4 of the present disclosure.

### DESCRIPTION OF EMBODIMENTS

For making the objectives, technical solutions and advantages of the present disclosure clearer, the present disclosure will be described in further detail below with reference to the accompanying drawings and the examples. It should be understood that the specific examples described herein are merely illustrative of the present disclosure and are not intended to limit the present disclosure. In addition, in the following descriptions, descriptions of well-known structures and technologies are omitted in order to avoid unnecessarily obscuring the concepts of the present disclosure.

In the descriptions of the present disclosure, it should be noted that when an element is referred to as being “fixed to” or “arranged on” another element, the element may be directly or indirectly on another element. When an element is referred to as being “connected to” another element, the element may be directly or indirectly connected to another element.

In the descriptions of the present disclosure, it should be noted that the terms “center”, “length”, “width”, “thickness”, “upper”, “lower”, “front” “back”, “left”, “right”, “vertical”, “horizontal”, “top”, “bottom” “inner”, “outer”, etc. indicate orientation or position relations based on those shown in the accompanying drawings, or of common placement when the product of the present disclosure is used, which are only for ease of description of the present disclosure and for simplicity of description, and are not intended to indicate or imply that the referenced device or element must have a particular orientation and be constructed and operated in a particular orientation, and thus may not be construed as a limitation on the present disclosure. Moreover, the terms “first”, “second”, “third”, etc. are used merely to distinguish between descriptions and may not be construed as indication or implication of relative importance. Thus, a feature defined with “first” and “second” may explicitly or implicitly include one or more of the features. In the description of the present disclosure, “a plurality of” means two or more, unless expressly specified otherwise. “Several” means one or more, unless expressly specified otherwise.

In the description of the present disclosure, it should be further noted that, unless otherwise clearly specified, meanings of terms “arrange”, “mount”, “connected” and “connect” should be understood in a board sense. For example, the connection may be a fixed connection, a detachable connection, an integral connection; may be a mechanical connection or an electrical connection; may be a direct connection or an indirect connection by using an intermediate medium; or may be intercommunication between two components. For those of ordinary skill in the art, the specific meanings of the above terms in the present disclosure may be understood according to specific circumstances.

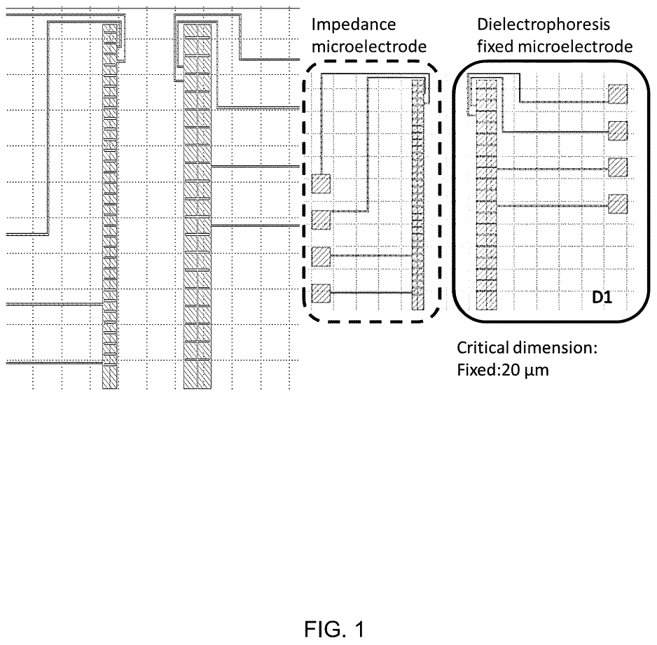

With reference to FIG. 1, the present disclosure provides a method for designing and fabricating a dielectrophoretic microelectrode actuator with an impedance sensor chip. The method includes arranging a dielectrophoretic microelectrode actuator connected to an output channel and three input channels on a semiconductor chip, and further includes arranging an impedance microelectrode sensor with one input channel and one output channel on the same semiconductor chip, where the impedance microelectrode sensor is arranged adjacent to the dielectrophoretic microelectrode actuator, a contact pad is arranged on the semiconductor chip, the contact pad has a size of 1650 μm×1650 μm, the dielectrophoretic microelectrode actuator and the impedance microelectrode sensor are arranged on the contact pad, and impedance microelectrode sensors and dielectrophoretic microelectrode actuators of different sizes can be arranged on the contact pad.

Regarding the present disclosure, several feasible examples involving a variety of detection system specifications are provided below.

### Example 1

With reference to FIG. 1, based on the above, the dielectrophoretic microelectrode actuator has a size of 900 μm×900 μm, a gap of 20 μm, and an internal microelectrode length of 800 μm; and the impedance microelectrode sensor has a size of 500 μm×500 μm, a gap of 20 μm, and an internal microelectrode length of 400 μm.

### Example 2

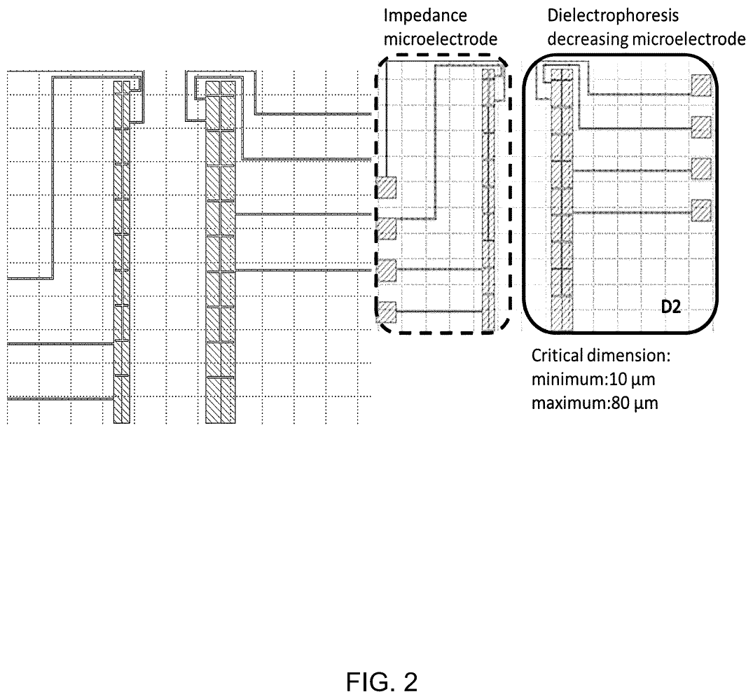

With reference to FIG. 2, based on the above, the dielectrophoretic microelectrode actuator has a size of 2000 μm×2000 μm, a gap of 80, 70, 60, 50, 40, 30, 20 or 10 μm, and an internal microelectrode length of 405 μm; and the impedance microelectrode sensor has a size of 2000 μm×505 μm, a gap of 80, 70, 60, 50, 40, 30, 20 or 10 μm, and an internal microelectrode length of 405 μm. The gaps between the microelectrodes of this example can be 80 μm, 70 μm, 60 μm, 50 μm, 40 μm, 30 μm, 20 μm and 10 μm respectively.

### Example 3

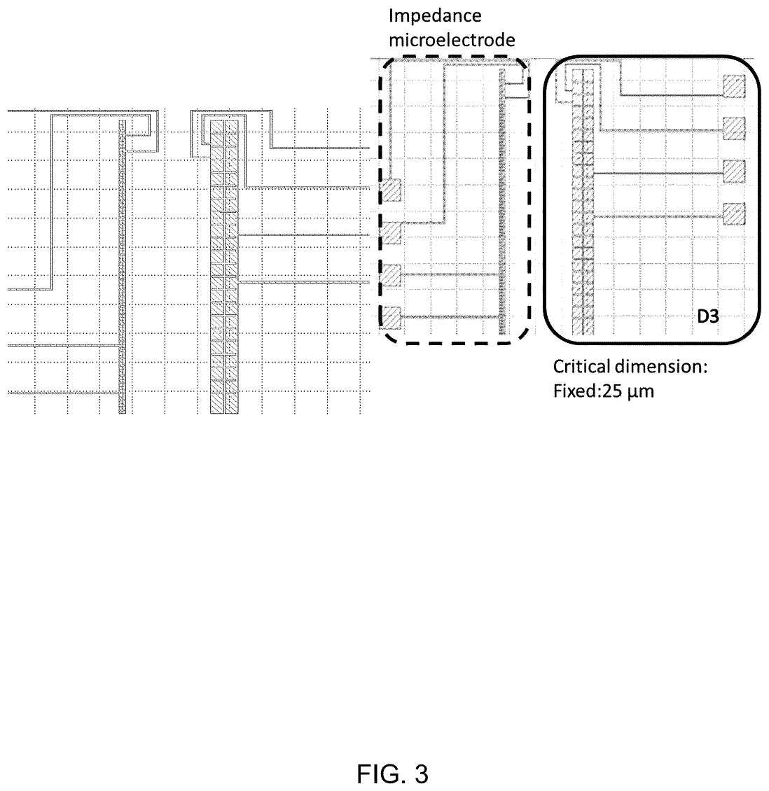

With reference to FIG. 3, based on the above, the dielectrophoretic microelectrode actuator has a size of 800 μm×800 μm, a gap of 25 μm, and an internal microelectrode length of 700 μm; and the impedance microelectrode sensor has a size of 200 μm×200 μm, a gap of 25 μm, and an internal microelectrode length of 100 μm.

### Example 4

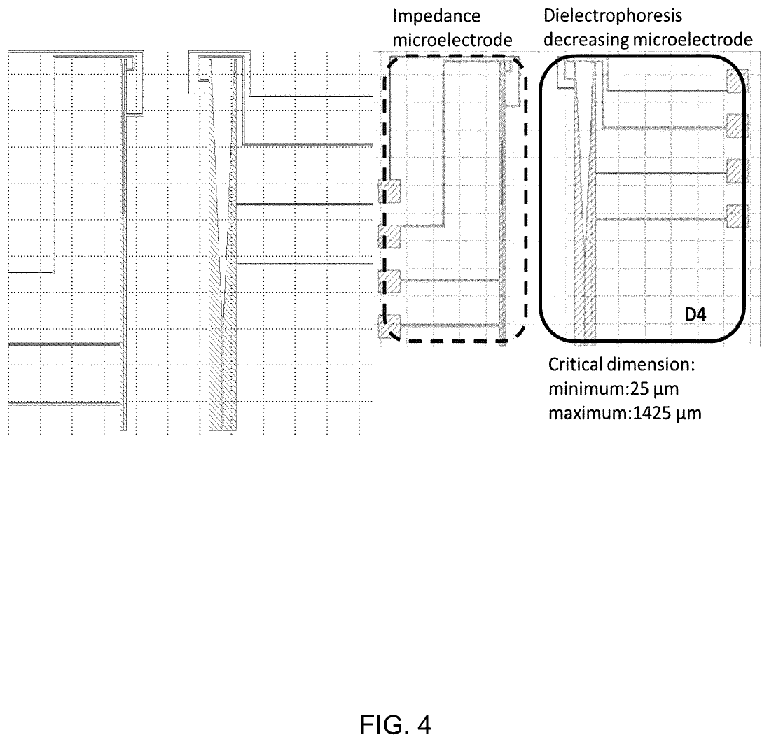

With reference to FIG. 4, based on the above, the dielectrophoretic microelectrode actuator has a length of 5000 μm on one side and 16700 μm on the other side, a gap of 25 μm, and symmetrical V-shaped microelectrodes formed on both sides; and the impedance microelectrode sensor has a length of 5000 μm on one side and 16700 μm on the other side, with a gap of 25 μm.

A top chip can be combined with a base chip in a resealable chip interface. Fluid can be pumped into the chip through a linear connector and flow over a surface of the base chip. A reagent, a sensor, a biosensor or cells can be deposited on a base layer of the chip. The base layer of the chip is usually made of glass, quartz, or polymers. Then the fluid flows through a channel in a gasket layer that is above the deposited sensor or reagent. A depth of the channel in the gasket layer generally ranges from 100 to 500 μm. Applications include: biosensor testing, cell culture and analysis, dielectrophoresis experiments, impedance detection, and connections to silicon chips and sensors.

Application of a device with three input channels and one output channel is enhanced by using a resealable chip interface for continuous flow of microfluids in a rapid and portable manner, and the reagent, sensor, biosensor or cells that can be deposited on the base layer of the chip of the device are retained in the channels.

Standard parts referenced in the present disclosure can be purchased from the market, and are connected through specific mature conventional connection methods of the prior art for bolts, rivets, welding and the like. Inner components such as electric sliding rail carriages, cylinders, welding machines, electric telescopic rods and controllers are of conventional models in the prior art, and their internal structures belong to structures of the prior art. Workers can perform normal operations according to manuals of the prior art, and conventional circuit connection methods of the prior art are adopted, so details are not described herein.

It should be noted that the above examples have been described herein, but are not intended to limit the patent scope of the present disclosure. Therefore, changes and modifications of made to the example described herein based on the innovative concepts of the present disclosure, or any equivalent structure or equivalent process transformation made by using the description of the present disclosure and the contents of the accompanying drawings, with the above technical solution directly or indirectly used in other related technical fields, are all included in the protection scope of the present disclosure.

What is claimed is:

1. A method for designing and fabricating a dielectrophoretic microelectrode actuator with an impedance sensor chip, comprising the following steps: arranging a dielectrophoretic microelectrode actuator connected to an output channel and three input channels on a semiconductor chip, and further arranging an impedance microelectrode sensor with one input channel and one output channel on the same semiconductor chip, wherein the impedance microelectrode sensor is arranged adjacent to the dielectrophoretic microelectrode actuator, a contact pad is arranged on the semiconductor chip, the contact pad has a size of 1650 μm×1650 μm, and the dielectrophoretic microelectrode actuator and the impedance microelectrode sensor are arranged on the contact pad.

2. The method for designing and fabricating a dielectrophoretic microelectrode actuator with an impedance sensor chip according to claim 1, wherein the dielectrophoretic microelectrode actuator has a size of 900 μm×900 μm, a gap of 20 μm, and an internal microelectrode length of 800 μm; and the impedance microelectrode sensor has a size of 500 μm×500 μm, a gap of 20 μm, and an internal microelectrode length of 400 μm.

3. The method for designing and fabricating a dielectrophoretic microelectrode actuator with an impedance sensor chip according to claim 1, wherein the dielectrophoretic microelectrode actuator has a size of 2000 μm×2000 μm, a gap of 80, 70, 60, 50, 40, 30, 20 or 10 μm, and an internal microelectrode length of 405 μm; and the impedance microelectrode sensor has a size of 2000 μm×505 μm, a gap of 80, 70, 60, 50, 40, 30, 20 or 10 μm, and an internal microelectrode length of 405 μm.

4. The method for designing and fabricating a dielectrophoretic microelectrode actuator with an impedance sensor chip according to claim 1, wherein the dielectrophoretic microelectrode actuator has a size of 800 μm×800 μm, a gap of 25 μm, and an internal microelectrode length of 700 μm; and the impedance microelectrode sensor has a size of 200 μm×200 μm, a gap of 25 μm, and an internal microelectrode length of 100 μm.

5. The method for designing and fabricating a dielectrophoretic microelectrode actuator with an impedance sensor chip according to claim 1, wherein the dielectrophoretic microelectrode actuator has a length of 5000 μm on one side and 16700 μm on the other side, a gap of 25 μm, and symmetrical V-shaped microelectrodes formed on both sides; and the impedance microelectrode sensor has a length of 5000 μm on one side and 16700 μm on the other side, with a gap of 25 μm.
